(19) United States
(12) Patent Application Publication
(10) Pub. No.: US 2019/0283679 A1
(43) Pub. Date: Sep. 19, 2019

(54) Retention Device

(71) Applicant: Lux-Liner LLC, Arcadia, CA (US)

(72) Inventors: Travis King, Arcadia, CA (US); Elisabeth Gritsch, Arcadia, CA (US); Michael Bowser, Irwindale, CA (US)

(21) Appl. No.: 15/920,916

(22) Filed: Mar. 14, 2018

(51) Int. Cl. B60R 7/04; B60R 7/08

(52) U.S. Cl. CPC B60R 7/04; F21S 9/02; B60R 7/08

(57) ABSTRACT

A retention device comprising at least one main body member and one or more anchoring members. The main body member may comprise a plurality of retainer loops, which may traverse along a longitudinal axis of the main body member and may be adapted to retain one or more objects. The anchoring members may comprise at least a first anchoring member and a second anchoring member. The anchoring members may further comprise one or more shafts and one or more bases. The main body member may extend between the first anchoring member and the second anchoring member and may be removably coupled to the anchoring members. The plurality of retainer loops may be adapted to engage the shafts of the anchoring members. The bases of the anchoring members may be adapted to removably attach the anchoring members to a surface.

### FIELD OF USE

The present disclosure relates generally to retention devices, and more particularly, to a retention device that may securely hold loose items on a horizontal or vertical flat surface.

### BACKGROUND

The majority of recreational vehicle (RV), motor home, camper, or travel trailer (hereinafter “RV”) interiors have been designed with organization and storage in mind. There are usually numerous cabinets, dressers, and compartments under the furniture within the interior. There may also be storage bays that are accessed from the outside of the RV. However, even with all the storage space, more ways to organize heavy loose objects is desirable. When traveling in an RV, it is important to secure all objects within the interior before driving. Additionally, RV owners are constantly seeking ways to maximize the interior space and reduce clutter. If RV owners do not clear counters, secure cabinets, and lock windows and drawers, they are likely to have to deal with breakage and mess when they finally stop driving. In particular, road vibration and road conditions are common problems when it comes to keeping personal possessions and household items stabilized while driving. Generally, state and interstate highways are now in very poor condition, which negatively affects the devices and possessions within the interior of an RV. However, these issues can be minimized by properly securing a RV's interior properly.

Therefore, there is a need for a new and improved retention device that may properly secure personal possessions and household items on horizontal and vertical surfaces while an RV is traveling. Preferably, the new retention device is durable and flexible, such that the retention device assembly may help organize and secure items of various sizes and shapes.

### SUMMARY OF ILLUSTRATIVE EMBODIMENTS

To minimize the limitations in the cited references, and to minimize other limitations that will become apparent upon reading and understanding the illustrative embodiments, the present disclosure teaches a new and useful retention device.

One embodiment may be a retention device, comprising at least one main body member and one or more anchoring members. The at least one main body member may comprise a plurality of retainer loops. The one or more anchoring members may comprise at least a first anchoring member and a second anchoring member. The plurality of retainer loops may traverse along a longitudinal axis of the at least one main body member. Each of the first anchoring member and the second anchoring member may comprise a shaft and a base. The at least one main body member may extend between the first anchoring member and the second anchoring member and may be removably coupled to the first anchoring member and the second anchoring member at different retainer loops. The plurality of retainer loops may be adapted to engage the shafts of the first and second anchoring members and to retain one or more objects. The bases of the first and second anchoring members may be adapted to removably attach the first and second anchoring members to a surface without altering the surface. The at least one main body member may be positioned in a substantially perpendicular manner to the surface. The plurality of retainer loops may be adapted to provide a uniform holding pressure against the one or more objects being retained by the plurality of retainer loops. The plurality of retainer loops may be separated by a plurality of seams. The at least one main body member may comprise two layers, wherein the two layers may be joined at a plurality of seams and wherein in between every two seams of the plurality of seams may be a pocket, such that the pocket and the two adjacent seams form one of the plurality of retainer loops. The at least one main body member may comprise a backing layer. The plurality of retainer loops may be permanently connected to the backing layer at a plurality of seams, such that a plurality of pockets may be formed. The plurality of retainer loops may be adapted to slide over the shafts of the first and second anchoring members. The one or more anchoring members may each further comprise a cap, such that there are at least two caps. Each of the at least two caps may be removably coupled to a top portion of the first and second anchoring members, such that the at least one main body member may be prevented from inadvertently being removed from the first and second anchoring members if already engaged with the first and second anchoring members. The one or more bases of the one or more anchoring members may comprise at least one neck portion. The at least one neck portion of the one or more bases may be coupled to a bottom portion of the one or more shafts. Each of the first and second anchoring members may comprise a light. Each base of the first and second anchoring members may comprise a surface attachment portion. The surface attachment portion may be one or more suction cups. The surface attachment portion may be one or more locking suction cups. The surface attachment portion may be one or more magnets. The surface attachment portion may be one or more electromagnets. The surface attachment portion may secure one or more wine bottles to a counter top of a recreation vehicle, such that when the recreation vehicle is moving the one or more wine bottles are prevented from falling off the counter top. One or more of the plurality of retainer loops may have bottoms that prevent objects from passing entirely through the one or more of the plurality of retainer loops. One or more of the plurality of retainer loops may have no bottoms.

Another embodiment may be a retention device, comprising at least one main body member and two or more anchoring members. The at least one main body member may comprise a plurality of retainer loops. The plurality of retainer loops may traverse along a longitudinal axis of the at least one main body member. Each of the two or more anchoring members may comprise a shaft and a base. The at least one main body member may extend between at least two of the two or more anchoring members and may be removably coupled to the at least two of the two or more anchoring members at different retainer loops. The plurality of retainer loops may be adapted to engage the shafts of the two or more anchoring members and to retain one or more objects. The bases of the two or more anchoring members may be adapted to removably attach the two or more anchoring members to a surface without altering the surface. The at least one main body member may be positioned in a substantially perpendicular manner to the surface. The plurality of retainer loops may be separated by a plurality of seams. The plurality of retainer loops may be adapted to slide over the shafts of the two or more anchoring members. The two or more anchoring members may each further comprise a cap, which may prevent the main body member from accidentally disengaging with the two or more anchoring members if already engaged with the two or more anchoring members. Each base of the two or more anchoring members may comprise a surface attachment portion. Each of the first and second anchoring members may comprise a light. The surface attachment portion may be selected from the group of surface attachment portions selected from: one or more suction cups; one or more locking suction cups; one or more magnets; and one or more electromagnets.

The retention device may be cost-effective to manufacture, yet sturdy, for the safe and secure storage of personal possessions and household items on a vertical or horizontal surface.

The retention device may easily adhere to a horizontal or vertical surface and may conveniently secure a plurality of objects of various sizes and shapes.

The retention device may easily and conveniently adhere to different locations on a horizontal or vertical surface without requiring modification of the surface or damage thereto.

Other features and advantages are inherent in the retention device claimed and disclosed will become apparent to those skilled in the art from the following detailed description and its accompanying drawings.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an illustration of side view of one embodiment of the retention device.

FIG. 2 is an illustration of a side view of one embodiment of the main body member.

FIG. 3 is an illustration of a top view of one embodiment of the main body member showing the retainer loops.

FIG. 4 is an illustration of a side view of one embodiment of the anchoring member.

FIG. 5 is an illustration of a top view of one embodiment of the anchoring member.

FIG. 6 is an illustration of a side view of one embodiment of the retention device securing a bottle.

FIG. 7 is an illustration of a top view of another embodiment of the retention device showing four anchoring members and four main body members.

FIG. 8 is an illustration of a close-up view of a top portion of another embodiment of the anchoring member.

FIGS. 9A to 9D are illustrations of bottom views of four embodiments of the surface attachment portions.

### DETAILED DESCRIPTION OF THE DRAWINGS

In the following detailed description of various embodiments of the present disclosure, numerous specific details are set forth in order to provide a thorough understanding of various aspects of one or more embodiments of the present disclosure. However, one or more embodiments of the present disclosure may be practiced without some or all of these specific details. In other instances, well-known methods, procedures, and/or components have not been described in detail so as not to unnecessarily obscure aspects of embodiments of the present disclosure.

While multiple embodiments are disclosed, still other embodiments of the present disclosure will become apparent to those skilled in the art from the following detailed description, which shows and describes illustrative embodiments of the present disclosure. As will be realized, the device of the present disclosure is capable of modifications in various obvious aspects, all without departing from the spirit and scope of the present disclosure. Accordingly, the figures, and the detailed descriptions thereof, are to be regarded as illustrative in nature and not restrictive. Also, the reference or non-reference to a particular embodiment of the present disclosure shall not be interpreted to limit the scope of the present disclosure.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the term “substantially perpendicular” refers to an angle of roughly or approximately 90° to a given line, plane, or surface. In various embodiments, “substantially perpendicular” may also refer to reasonably acute angles and reasonably obtuse angles.

As used herein, the terms “approximately” and “about” generally refer to a deviance of within 15% of the indicated number or range of numbers. In one embodiment, the term “approximately” and “about”, refer to a deviance of between 0.0001-40% from the indicated number or range of numbers.

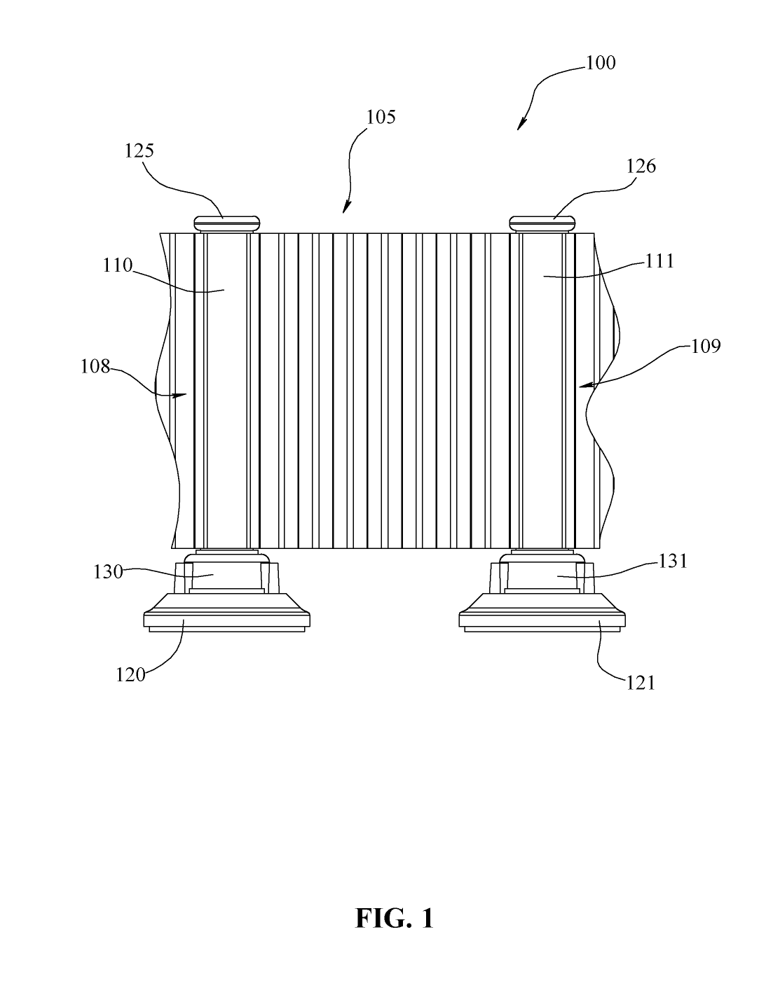

FIG. 1 is an illustration of side view of one embodiment of the retention device. As shown in FIG. 1, the retention device 100 may comprise at least one main body member 105 and one or more anchoring members 108, 109. The main body member 105 may extend between a first 108 and second 109 anchoring member. The main body member 105 may comprise a plurality of retainer loops 115. The retainer loops 115 may traverse along a longitudinal axis of the main body member 105. The retainer loops 115 may be adapted to retain one or more objects on a horizontal or vertical surface such that the objects are held substantially in place. Each retainer loop 115 may be adapted to provide a uniform holding pressure against the object being retained regardless of its weight or dimensions and independently of any other objects being retained by other retainer loops 115. The actual number of retainer loops 115 may vary depending upon the number, size, and weight of the objects to be retained. The retainer loops 115 are shown having a uniform width, but they may be all different or may be one of several standard sizes. The retainer loops 115 may be bounded by seams 200, which may define a width of the retainer loops 115.

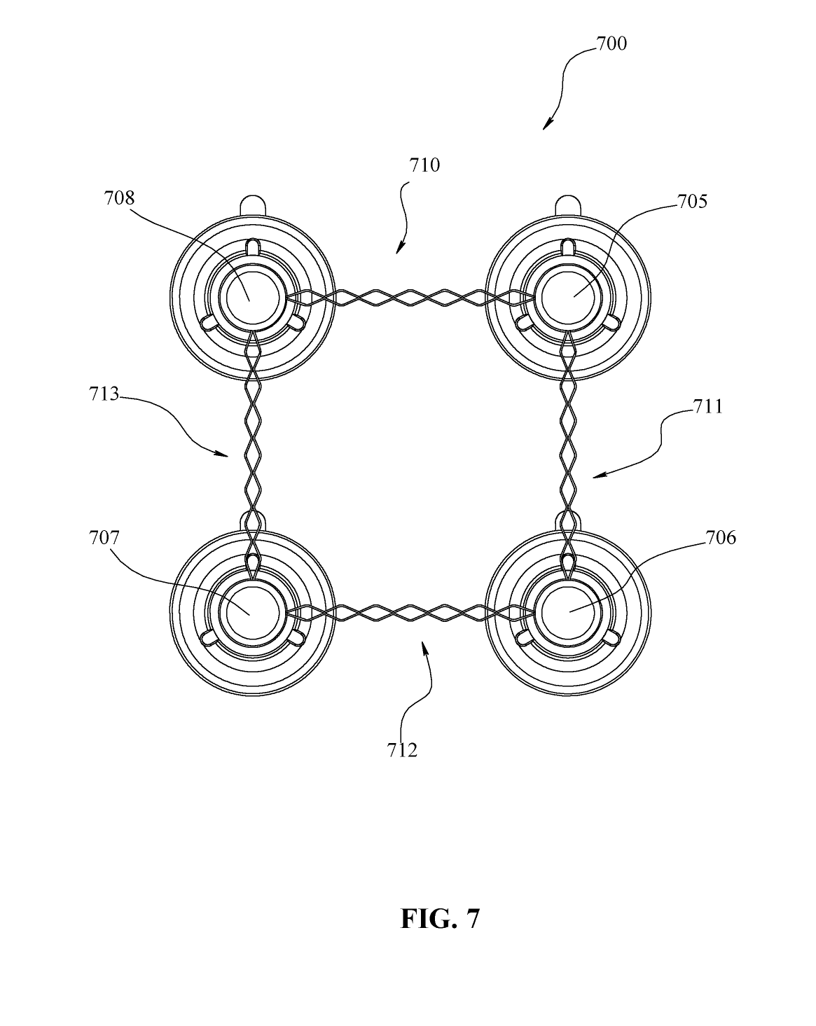

The main body member 105 may act as a net or separator to keep objects on one side of the main body member from moving or moving past the main body member 105. One embodiment of this is shown in FIG. 7.

The main body member 105 may removably couple with the anchoring members 108, 109. In one embodiment, the retainer loops 115 of the main body member 105 may be adapted to engage the shafts 110, 111 of the anchoring members 108, 109. The retainer loops 115 of the main body member 105 may be adapted to slide over the shafts 110, 111 of the anchoring members 108, 109. The anchoring members 108, 109 may provide lateral support to the main body member 105. The main body member 105 may be adapted to be positioned in a substantially perpendicular manner to a horizontal or vertical surface, such as, but not limited to, a countertop or wall. The main body member 105 may engage with the anchoring members in many different ways, including connectors, temporary adhesives, straps, hook and loop straps, snaps, buttons, clasps, and the like.

FIG. 1 shows the anchoring members 108, 109 may comprise one or more shafts 110, 111, one or more bases 120, 121, and one or more caps 125, 126. The caps 125, 126 may be removably coupled to a top portion of the shafts 110, 111 and the bases 120, 121 may be removably coupled to a bottom portion of the shafts 110, 111. The anchoring members 108, 109 may be substantially rigid (yet potentially flexible) and may be manufactured from any durable, lightweight material capable of withstanding external forces, such as those forces exerted by a user when attaching or removing the anchoring members 108, 109 to or from a horizontal or vertical surface, or attaching the main body member to the anchoring members. In particular, the anchoring members 108, 109 may be designed to be sufficiently flexible so that a user may easily store and remove one or more objects within the retainer loops 115 of the main body member 105 and without disconnecting the bases 120, 121 from a horizontal or vertical surface. The bases 120, 121 may be adapted to removably attach the shafts 110, 111 to a horizontal or vertical surface. Preferably, the bases 120, 121 may comprise one or more surface attachment portions, such as one or more suction cups, one or more locking suction cups, or one or more magnets. Preferably base 120 is removably coupled with shaft 110 and base 121 is removably coupled with shaft 111. The bases 120, 121 may attach to any relatively flat, smooth, horizontal or vertical surface. The surface may have different textures, such as, but not limited to, tile, glass, granite, or laminate. The bases 120, 121 may be manufactured from rubber or some other suitable material. The optional neck portions 130, 131 may be between the shaft 110, 111 and the base 120, 121. The neck portions 130, 131 may be adapted to removeably engage with the bottom of the main body member 105 or may be configured to prevent the main body member 105 from sliding all the way down to the surface of which the bases 120, 121 are attached. The actual number, size, and location of the anchoring members 108, 109 may vary depending on the intended use of the retention device 100.

When desired, a user may move the anchoring members 108, 109 to different retainer loops 115 or to locations on a horizontal or vertical surface by easily disconnecting and re-connecting the bases 120, 121. Or the device 100 may be disconnected and moved to an entirely different surface. The bases 120, 121 may be adapted to securely hold the anchoring members 108, 109 having a main body member 105 attached thereto on a horizontal or vertical surface for long periods of time.

The retention device 100 may be cost-effective to manufacture, yet sturdy, for the safe and secure storage of objects on a horizontal or vertical surface. The retention device 100 may be used in a permanent or temporary manner without requiring modification or causing damage to the horizontal or vertical surface.

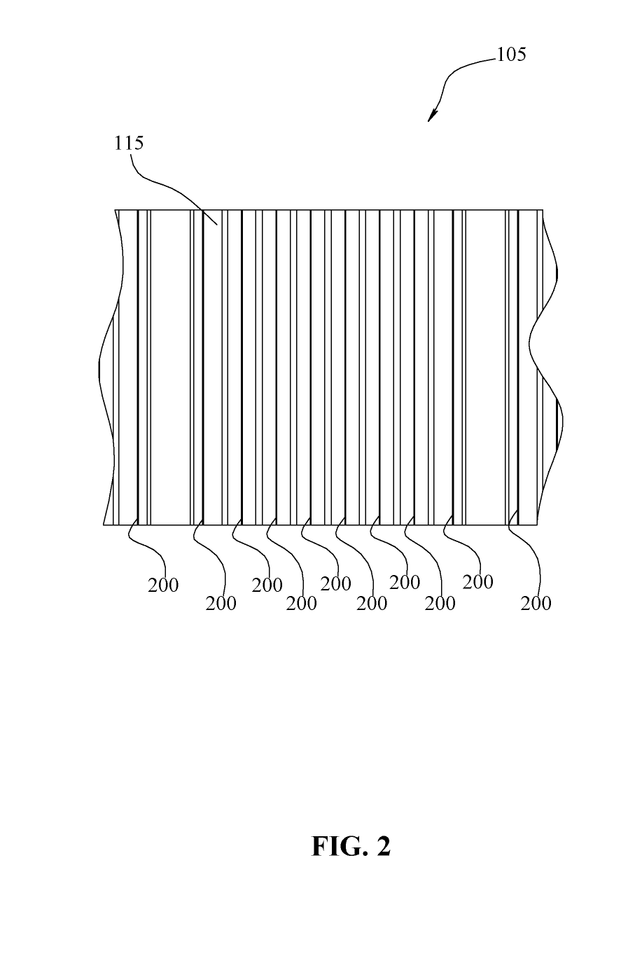

FIG. 2 is an illustration of a side view of one embodiment of the main body member. As shown in FIG. 2, the main body member 105 may be in the form of an elongated, flexible, substantially elastic, and generally rectangular, sheet of fabric, webbing, or the like. The main body member 105 may be removably coupled to or engaged with one or more shafts of one or more anchoring members. The main body member 105 may comprise a plurality of retainer loops 115. The actual width, shape, and number of retainer loops 115 may vary depending upon the number, size, and weight of the objects to be retained. The retainer loops 115 may be adapted to securely retain one or more objects on a horizontal or vertical surface. As shown in FIG. 1, the height of the main body member 105 may extend may extend at least substantially the length of the shafts. In other embodiments, the main body member 105 may be shorter than the length of the shafts. Depending on the placement of the retention device 100, the main body member 105 may be generally horizontal or vertical with respect to the ground. In one embodiment, when the retention device is secured to a horizontal surface, the main body member 105 may be substantially vertical relative to the ground. In another embodiment, when the retention device is secured to a vertical surface, the main body member 105 may be substantially horizontal relative to the ground. In another embodiment, the retention device may be secured to a horizontal and vertical surface at the same time, in which the main body member 105 may be both horizontal and vertical.

The main body member 105 may be formed by securing together two or more sheets of fabric, webbing, plastic, or other suitable material, by stitching, adhesive, heat sealing, or other suitable connection device or system, to form a plurality of retainer loops 115. The retainer loops 115 may be secured around the shafts of the anchoring members and may secure one or more objects on a horizontal or vertical surface. As shown in FIG. 2, the main body member 105 may comprise one or more seams 200 (which may be a column of stitching/joining) that run the height/length of the main body member 105.

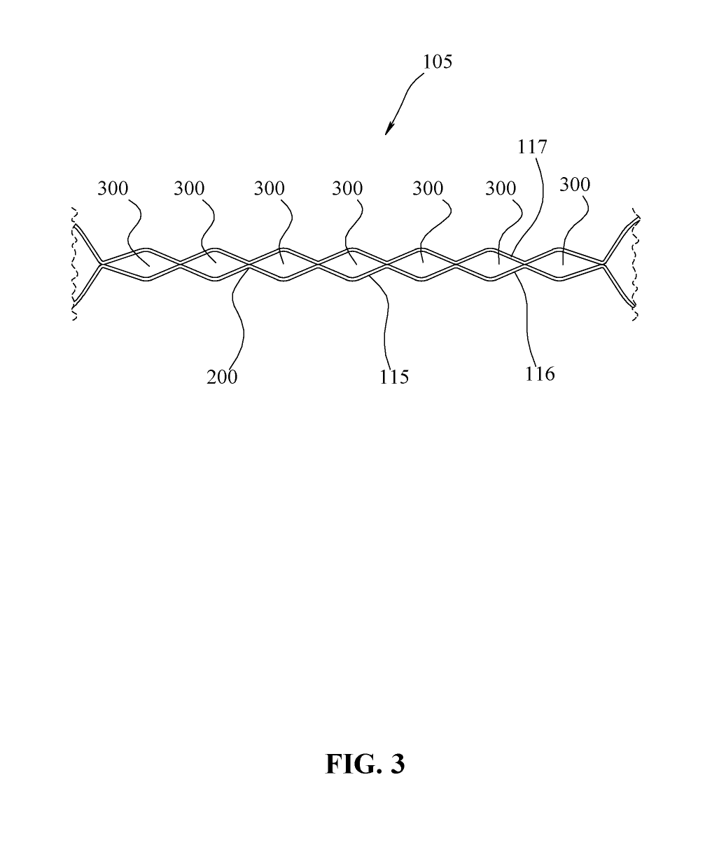

FIG. 3 is an illustration of a top view of one embodiment of the main body member showing the retainer loops. As shown in FIG. 3, the main body member 105 may comprise a plurality of retainer loops 115. The retainer loops 115 may form a series of vertically or horizontally disposed pockets 300 that are formed between seams 200. The pockets 300, as shown, are configured to hold various objects, such as wine bottles, in a manner that is perpendicular to the surface to which the device is attached. Because objects on a horizontal or vertical surface may differ in weight and dimension, the pockets 300 may be manufactured from any type of adjustable material, such as, elastic, webbing, spandex, nylon, stretch vinyl, stretch fabric, or the like, such that the pockets 300 may retain objects of various weights and dimensions. In the embodiment shown in FIG. 3, the main body member 105 may comprise two layers of material 116, 117, which are form one or more retainer loops 300 formed by loop layers 116, 117 by seams 200. The pockets and/or retainer loops may have no bottom or they may have a bottom to prevent objects from passing through.

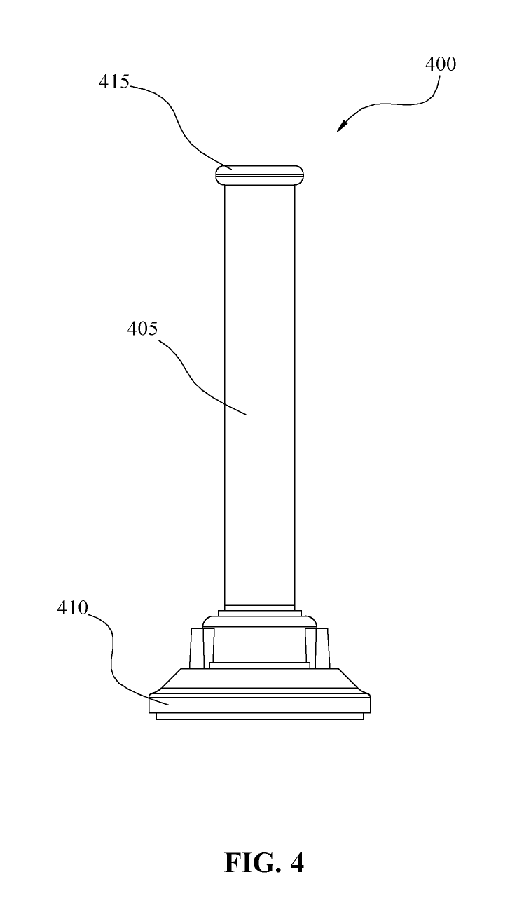

FIG. 4 is an illustration of a side view of one embodiment of the anchoring member. The anchoring member 400 may comprise one or more shafts 405, one or more bases 410, and one or more caps 415. Depending on the placement of the retention device (vertical or horizontal surface), the anchoring member 400 may be substantially horizontal or substantially vertical relative to the ground. In one embodiment, when the retention device is secured to a horizontal surface, the anchoring member 400 may be substantially vertical. In another embodiment, when the retention device is secured to a vertical surface, the anchoring member 400 may be substantially horizontal. In another embodiment, when the retention device comprises two or more anchoring members 400, the retention device may be simultaneously secured to a horizontal and vertical surface, in which the anchoring members 400 may be generally horizontal and vertical. The shafts 405 of the anchoring member 400 may be attached to different retainer loops of the main body member. Preferably, the retention device may be secured to a horizontal or vertical surface by the bases 410.

Preferably, the base 410 may comprise one or more surface attachment portions, such as one or more suction cups, one or more locking suction cups, or one or more magnets that are integrated with or coupled to the shafts 405 such that the retention device may be secured to a horizontal or vertical surface. The surface attachment portions of the bases 410 may comprise any suitable connection or attachment device that may be firmly applied to a horizontal or vertical surface to securely and removeably hold the retention device in place. Firm pressure may be applied to the anchoring members 400 to facilitate the adhesion of the anchoring members 400 to the surface. The shafts 405 may be manufactured from any suitable material such as, but not limited to, metal, wood, or, plastic.

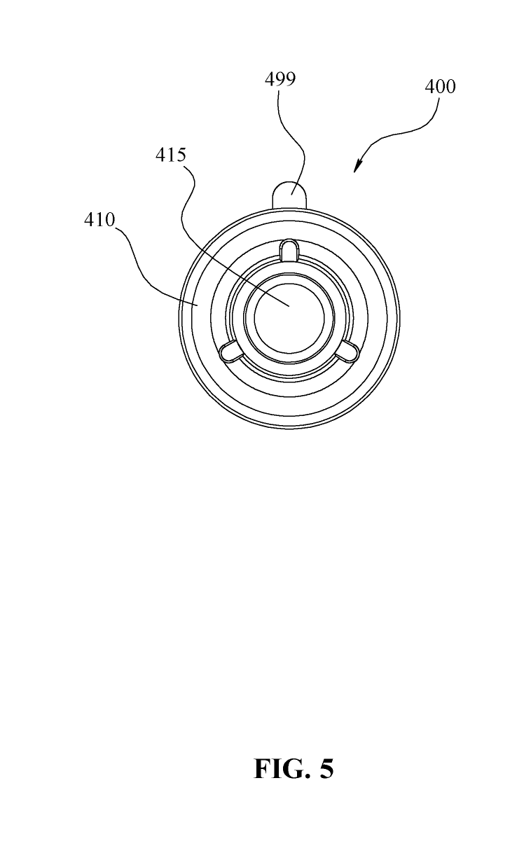

FIG. 5 is an illustration of a top view of one embodiment of the anchoring member. The anchoring member 400 may comprise suction cup lever 499, which may be a pull tab, one or more bases 410, and one or more caps 415.

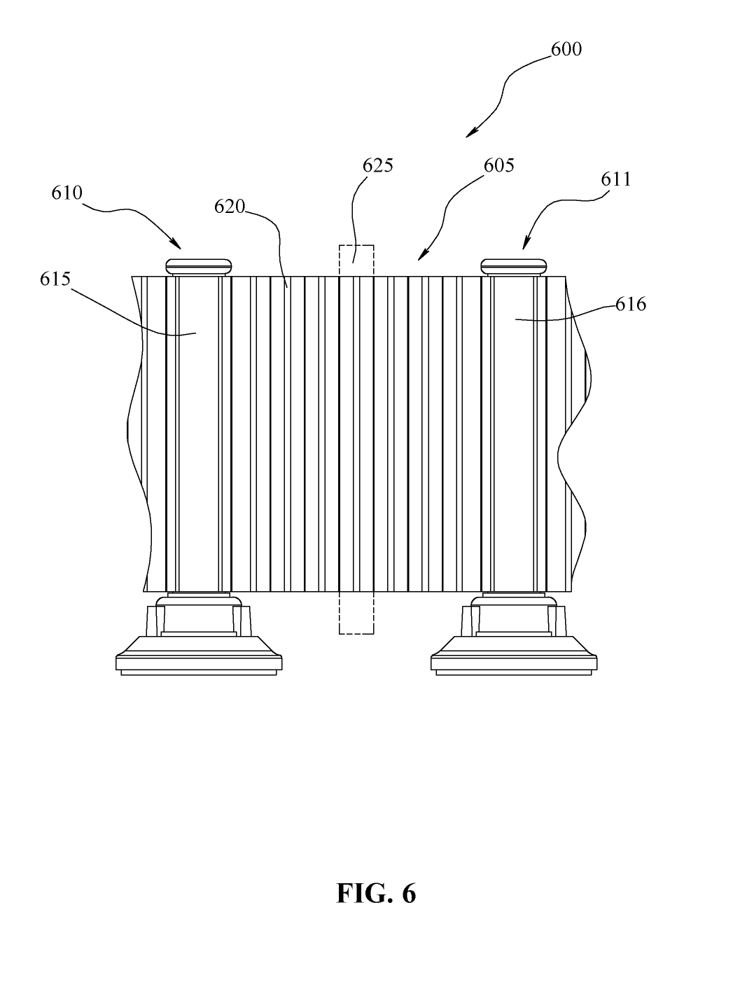

FIG. 6 is an illustration of a side view of one embodiment of the retention device securing a bottle. As shown in FIG. 6, the retention device 600 may comprise at least one main body member 605 and one or more anchoring members 610, 611. Preferably, the main body member 605 may comprise one or more elongated sheets of flexible and/or elastic fabric, plastic, or webbing, which may removably couple with one or more shafts 615, 616 of the anchoring members 610, 611. Further, the main body member 605 may comprise a plurality of retainer loops 620. In one embodiment, retainer loop 620 may engage the body of a wine bottle 625 as the wine bottle 625 passes completely through, or at least partially into, the retainer loop 620. The retainer loop 620 may securely retain the wine bottle 625 to prevent inadvertent slippage, as for example, when in a moving vehicle, such as an RV. To secure the wine bottle 625 within the retainer loop 620, the wine bottle 625 may be inserted into the retainer loop 620 or the retainer loop 620 may be placed over the wine bottle 625 such that the body of the wine bottle 625 is securely retained within the retainer loop 620. Specifically, for purposes of illustration and not by way of limitation, a wine bottle 625 is shown retained within the retainer loop 620. However, it should be understood and appreciated that other objects, such as jars, utensils, electronics, cords, and the like, may also be retained within the retention device 600. Furthermore, the retainer loop is shown as extending the entire length/height of the main body member 605, but each retainer loop may be more than one loop, which spaces between each loop, or may a single loop (which would look like a strap) that is shorter than the height of the main body member 605. Other embodiments might have a retainer loop that is one or more pockets with bottoms, such that smaller articles might be inserted into the vertically stacked pockets.

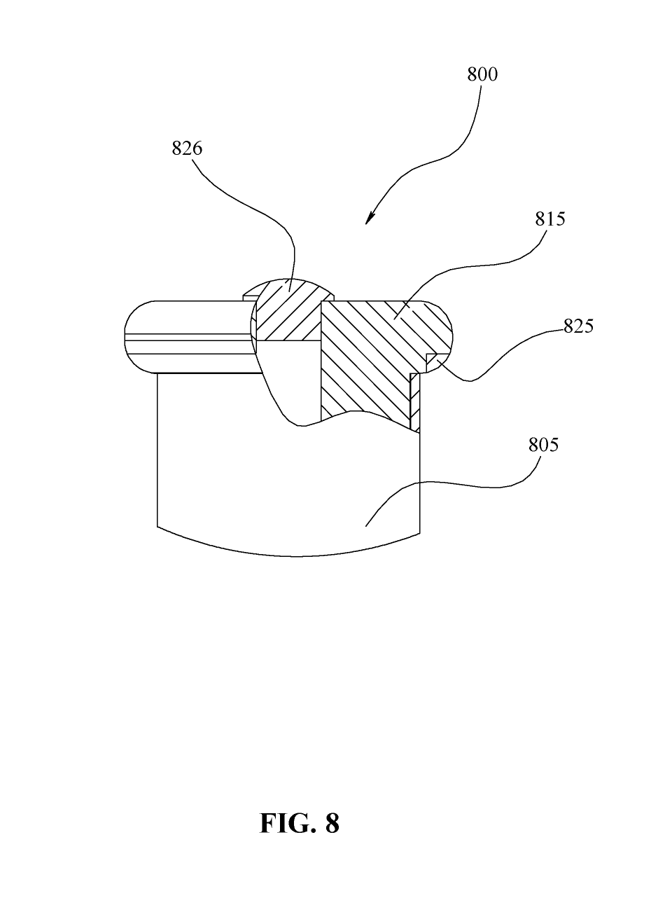

FIG. 7 is an illustration of a top view of another embodiment of the retention device showing four anchoring members and four main body members. As shown in FIG. 8, the retention device 700 may comprise one or more anchoring members 705, 706, 707, 708 and one or more main body member sides 710, 711, 712, 713. FIG. 7 shows how the retention device 700 may be used in different configurations, which in this case is shown as a four-sided bin 799, wherein the surface serves as the bottom of the bin 799 and the one or more main body member sides 710, 711, 712, 713 are the sides of the bin 799. In this manner, the retention device 700 may securely hold larger items in with in the bin 799. In other embodiments, the user may form a bin on a horizontal surface by using one or more vertical surfaces as sides of the bin.

FIG. 8 is an illustration of a close-up view of a top portion of another embodiment of the anchoring member. As shown in FIG. 8, the anchoring member 800 may comprise one or more shafts and one or more caps 815. The one or more caps 815 may be removably coupled to the anchoring member 800. In one embodiment, the shaft of the anchoring member 800 may be adapted to accept one or more batteries such that the cap 815 may further comprise light 825. In one embodiment, the anchoring member 800 may comprise a light emitting diode (LED) system 825. Further, the cap 415 may be sufficiently secured to the shaft of the anchoring member 800 such that the main body member may be held in place and prevented from inadvertently sliding off the shaft 805. The light 825 may be turned on/off by a button or motion sensor 826.

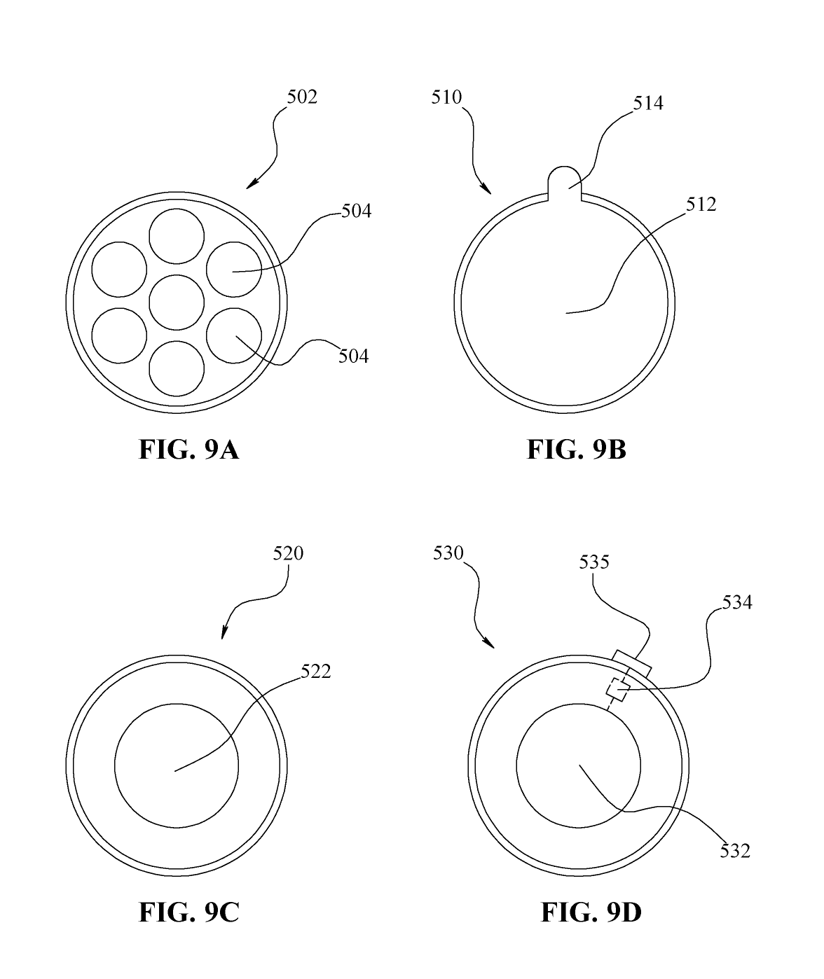

FIGS. 9A to 9D are illustrations of bottom views of four embodiments of the surface attachment portions. As shown in FIG. 9A, the base 502 of the anchoring member may comprise one or more suction cups 504. The suction cups 504 preferably hold the anchoring member to the surface when the user engages the base 502 with the surface.

As shown in FIG. 9B, the base 510 of the anchoring member may comprise one or more locking suction cups 512 and lever 514. Once in place on the surface, the user shifts the lever 514 to engage suction cup 512 with the surface. When the user wants to remove the anchoring member from the surface, the suction cup 512 may be unlocked by using lever or pull tab 514.

FIG. 9C shows that the base 520 may comprise one or more integrated or attached magnets 522, which allows the user to engage the anchoring member on a metal surface. Preferably the magnet 522 is a rare earth (very strong) magnet.

FIG. 9D shows that the base 530 may comprise one or more electro-magnets 532, switch 535 and power supply 534. Once in place on the surface, the user shifts the switch 535 (which may be an analog button or digital button) to engage magnet 532 with the surface. When the user wants to remove the anchoring member from the surface, the magnet 532 may be turned off using switch 535.

The foregoing description of the specific embodiments will so fully reveal the general nature of the present disclosure that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments of the present disclosure have been described in terms of preferred embodiments, those skilled in the art will recognize that the embodiments of the present disclosure can be practiced with modification within the spirit and scope of the appended claims.

Unless otherwise stated, all measurements, values, ratings, positions, magnitudes, sizes, locations, and other specifications which are set forth in this specification, including in the claims which follow, are approximate, not exact. They are intended to have a reasonable range which is consistent with the functions to which they relate and with what is customary in the art to which they pertain.

The foregoing description of the embodiments has been presented for the purposes of illustration and description. While multiple embodiments are disclosed, still other embodiments will become apparent to those skilled in the art from the above detailed description. As will be realized, these embodiments are capable of modifications in various obvious aspects, all without departing from the spirit and scope of the protection. Accordingly, the detailed description is to be regarded as illustrative in nature and not restrictive. Also, although not explicitly recited, one or more embodiments may be practiced in combination or conjunction with one another. Furthermore, the reference or non-reference to a particular embodiment shall not be interpreted to limit the scope of protection. It is intended that these embodiments not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

What is claimed is:

1. A retention device, comprising:
at least one main body member, comprising a plurality of retainer loops; and
one or more anchoring members, comprising at least a first anchoring member and a second anchoring member;
wherein said plurality of retainer loops traverse along a longitudinal axis of said at least one main body member;
wherein each of said first anchoring member and said second anchoring member comprise a shaft and a base;
wherein said at least one main body member extends between said first anchoring member and said second anchoring member and is removably coupled to said first anchoring member and said second anchoring member at different retainer loops;
wherein said plurality of retainer loops are adapted to engage said shafts of said first and second anchoring members and to retain one or more objects;
wherein said bases of said first and second anchoring members are adapted to removably attach said first and second anchoring members to a surface without altering said surface; and
wherein said at least one main body member is positioned in a substantially perpendicular manner to said surface.

2. The retention device of claim 1, wherein said plurality of retainer loops are adapted to provide a uniform holding pressure against said one or more objects being retained by said plurality of retainer loops.

3. The retention device of claim 1, wherein said plurality of retainer loops are separated by a plurality of seams.

4. The retention device of claim 1, wherein said at least one main body member comprises two layers, wherein said two layers are joined at a plurality of seams and wherein in between every two seams of said plurality of seams is a pocket, such that said pocket and said two adjacent seams form one of said plurality of retainer loops.

5. The retention device of claim 1, wherein said at least one main body member comprises a backing layer; and
wherein said plurality of retainer loops are permanently connected to said backing layer at a plurality of seams, such that a plurality of pockets are formed.

6. The retention device of claim 1, wherein said plurality of retainer loops are adapted to slide over said shafts of said first and second anchoring members.

7. The retention device of claim 1, wherein said one or more anchoring members each further comprise a cap, such that there are at least two caps; and
wherein each of said at least two caps are removably coupled to a top portion of said first and second anchoring members, such that said at least one main body member is prevented from inadvertently being removed from said first and second anchoring members if already engaged with said first and second anchoring members.

8. The retention device of claim 1, wherein said one or more bases of said one or more anchoring members comprise at least one neck portion; and
wherein said at least one neck portion of said one or more bases is coupled to a bottom portion of said one or more shafts.

9. The retention device of claim 1, wherein each of said first and second anchoring members comprise a light.

10. The retention device of claim 1, wherein each base of said first and second anchoring members comprise a surface attachment portion.

11. The retention device of claim 10, wherein said surface attachment portion is one or more suction cups.

12. The retention device of claim 10, wherein said surface attachment portion is one or more locking suction cups.

13. The retention device of claim 10, wherein said surface attachment portion is one or more magnets.

14. The retention device of claim 10, wherein said surface attachment portion is one or more electromagnets.

15. The retention device of claim 10, wherein said surface attachment portion secures one or more wine bottles to a counter top of a recreation vehicle, such that when said recreation vehicle is moving said one or more wine bottles are prevented from falling off said counter top.

16. The retention device of claim 1, wherein one or more of said plurality of retainer loops have bottoms that prevent objects from passing entirely through said one or more of said plurality of retainer loops.

17. The retention device of claim 1, wherein one or more of said plurality of retainer loops have no bottoms.

18. A retention device, comprising:
at least one main body member, comprising a plurality of retainer loops; and
two or more anchoring members;
wherein said plurality of retainer loops traverse along a longitudinal axis of said at least one main body member;
wherein each of said two or more anchoring members comprise a shaft and a base;
wherein said at least one main body member extends between at least two of said two or more anchoring members and is removably coupled to said at least two of said two or more anchoring members at different retainer loops;
wherein said plurality of retainer loops are adapted to engage said shafts of said two or more anchoring members and to retain one or more objects;
wherein said bases of said two or more anchoring members are adapted to removably attach said two or more anchoring members to a surface without altering said surface;
wherein said at least one main body member is positioned in a substantially perpendicular manner to said surface;
wherein said plurality of retainer loops are separated by a plurality of seams;
wherein said plurality of retainer loops are adapted to slide over said shafts of said two or more anchoring members;
wherein said two or more anchoring members each further comprise a cap, which prevents said main body member from accidentally disengaging with said two or more anchoring members if already engaged with said two or more anchoring members;
wherein each base of said two or more anchoring members comprise a surface attachment portion.

19. The retention device of claim 18, wherein each of said first and second anchoring members comprise a light.

20. The retention device of claim 19, wherein said surface attachment portion is selected from the group of surface attachment portions selected from: one or more suction cups; one or more locking suction cups; one or more magnets; and one or more electromagnets.
